(19) United States
(12) Patent Application Publication
(10) Pub. No.: US 2014/0192369 A1
(43) Pub. Date: Jul. 10, 2014

(54) AUTOMATIC PRINTING ADJUSTMENT METHOD FOR PAGE-WIDTH ARRAY PRINTING DEVICE

(71) Applicant: MICROJET TECHNOLOGY CO., LTD, Hsinchu (TW)

(72) Inventors: Kwo-Yuan Shi, Hsinchu (TW); Ching-Sung Lin, Hsinchu (TW); Wei-Lun Ma, Hsinchu (TW); Hsueh-Kuan Shih, Hsinchu (TW)

(73) Assignee: MICROJET TECHNOLOGY CO., LTD, Hsinchu (TW)

(21) Appl. No.: 14/141,905

(22) Filed: Dec. 27, 2013

(30) Foreign Application Priority Data
Jan. 4, 2013 (TW) 102100356

(51) Int. Cl. G06K 15/02; H04N 1/00; G06K 15/10

(52) U.S. Cl. CPC G06K 15/027; G06K 15/102; H04N 1/00015; H04N 1/00082
USPC 358/1.8

(57) ABSTRACT

An automatic printing adjustment method for a page-width array printing device is provided. The page-width array printing device includes a printing module, a scanning module and a print region. Firstly, the printing module prints a print medium placed on the print region to obtain a printed image, and the scanning module scans the printed image of the print medium. Then, the printed image is transmitted from the scanning module to a processor. Then, a noise eliminating operation, a tilt calibration operation, a ROI selecting operation, a horizontal detection operation and a vertical detection operation are performed on the printed image. Afterwards, a calibrating result is feedback from the processor to the printing module. The printing conditions of nozzles of the respective inkjet head structures are adjusted according to the calibrating result.

### FIELD OF THE INVENTION

The present invention relates to a printing adjustment method, and more particularly to an automatic printing adjustment method for a page-width array printing device.

### BACKGROUND OF THE INVENTION

With increasing development of personal computers, printing devices are widely used as peripheral devices of computer systems. However, if the mechanism of the printing device has an assembling error, an inkjet head of the printing device is misaligned or the position of the inkjet head is shifted due to long-term use, the printing quality of the printing device is deteriorated.

In case that the printed image on the print medium is oblique or shifted and the quality of the printed document is impaired, it is necessary to calibrate the printing device. Conventionally, a manual printing calibration method is provided to calibrate the printing device. In the manual printing calibration method, a calibration page is firstly outputted from the printing device, and then the calibration parameters are determined by the user according to the visual judgment with respect to the printed page. FIG. 1 schematically illustrates a calibration page of a conventional manual printing calibration method of a printing device. After a plurality of calibration parameters are manually adjusted by the user, the calibration page 1 outputted from the printing device contains a plurality of calibration sets A1, A2, A3, B6, B7 and B8. Since the calibration sets A2 and B7 have the minimum errors according to visual judgment, the calibration sets A2 and B7 are selected as the X-axis calibration parameter and the Y-axis calibration parameter, respectively.

Since the manual printing calibration method needs the visual judgment, the images of the calibration sets should be as simple as possible. Under this circumstance, the calibrating efficacy is usually unsatisfied. Moreover, since the manual printing calibration method is time-consuming and complicated, the applications of the printing device are restricted by the manual printing calibration method. In other words, the manual printing calibration method is not user-friendly and unable to achieve precise printing calibration.

For solving the above drawbacks, a semi-automatic printing calibration method is disclosed. In the semi-automatic printing calibration method, a portion of the printing calibrating procedure is manually done, and the other portion of the printing calibrating procedure is performed by an image scanner or an image identification device with some specific calibrating parameters. FIG. 2 is a schematical flowchart illustrating a conventional semi-automatic printing calibration method of a printing device. Firstly, a calibration page 21 is outputted from a printing device 20. For correcting the printing error of the calibration page 21, the calibration page 21 is placed on the image scanner 22 (or the image identification device). Then, the image of the calibration page 21 is processed by using some specific calibrating parameters of the image scanner 22 (or the image identification device). For example, the image of the calibration page 21 is scaled down with the same scaling factors on the length and the width of the calibration page 21 so as to output calibrated and scaled down image on the page 21′. Certainly, the optimal calibrating parameters are automatically generated and provided by the image scanner 22 (or the image identification device), and it is not limited to the calibrating parameters of scaling down the image.

As known, the semi-automatic printing calibration method is more advantageous than the manual printing calibration method because the manual operation is reduced and the calibrating efficacy is enhanced. However, the semi-automatic printing calibration method also needs the manual operation. As shown in FIG. 2, the procedure of placing the calibration page 21 on the image scanner or the image identification device is manually done. If the image scanner or the image identification device is not equipped with a mechanism for stably and precisely fixing the calibration page 21, the manual error is increased. In other words, the calibrating efficacy of the semi-automatic printing calibration method is still unsatisfied. Moreover, the semi-automatic printing calibration method is still time-consuming and inconvenient.

From the above discussions, the conventional printing calibration method may result in artificially-made calibrating error. Moreover, since the conventional printing calibration method is mainly used to calibrate the inkjet head structure, after the calibration parameters are determined, all of the nozzles of the inkjet head structure are simultaneously calibrated. In other words, the conventional printing calibration method fails to individually calibrate a specified nozzle. Under this circumstance, the calibrating resolution is very rough.

After the calibration parameters are determined, all of the nozzles of the inkjet head structure are calibrated with the same displacement. Due to the installation, the fabricating process or other factors (e.g. clogged condition), different nozzles have different errors. Since the nozzles are simultaneously calibrated, some of the nozzles may be well calibrated but some of the nozzles may be poorly calibrated. The rough calibrating resolution may adversely affect the calibrating capability of the printing device.

Therefore, there is a need of providing an automatic printing adjustment method for a page-width array printing device in order to minimize the artificially-made printing calibrating error, increase the calibrating resolution and automatically detect the calibrating result.

### SUMMARY OF THE INVENTION

The present invention provides an automatic printing adjustment method for a page-width array printing device. The scanning module is arranged downstream of the printing module, and the printing module and the scanning module are arranged in parallel. Especially, the printing procedure of the printing module and the image capturing procedure of the scanning module are simultaneously or sequentially performed. After some specific calibration operations are performed, the print result is automatically detected, the artificially-made printing calibrating error is minimized, the calibrating resolution is increased, and the calibrating efficacy and the image quality are both enhanced.

In accordance with an aspect of the present invention, there is provided an automatic printing adjustment method for a page-width array printing device. The page-width array printing device includes a printing module, a scanning module and a print region. The printing module includes a plurality of inkjet head structures. Each inkjet head structure includes a plurality of nozzles. The automatic printing adjustment method includes the following steps. Firstly, the printing module prints a print medium placed on the print region to obtain a printed image, and the scanning module scans the printed image of the print medium. Then, the printed image is transmitted from the scanning module to a processor. Then, the processor performs a noise eliminating operation, a tilt calibration operation, a ROI selecting operation, a horizontal detection operation and a vertical detection operation on the printed image. Afterwards, a calibrating result is feedback from the processor to the printing module. The printing conditions of the nozzles of the respective inkjet head structure are adjusted according to the calibrating result.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a calibration page of a conventional manual printing calibration method of a printing device;

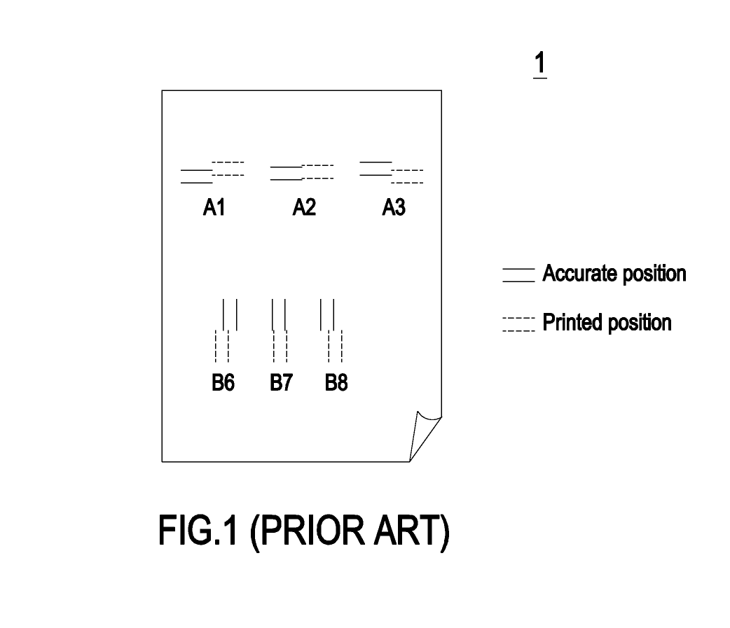

FIG. 2 is a schematical flowchart illustrating a conventional semi-automatic printing calibration method of a printing device;

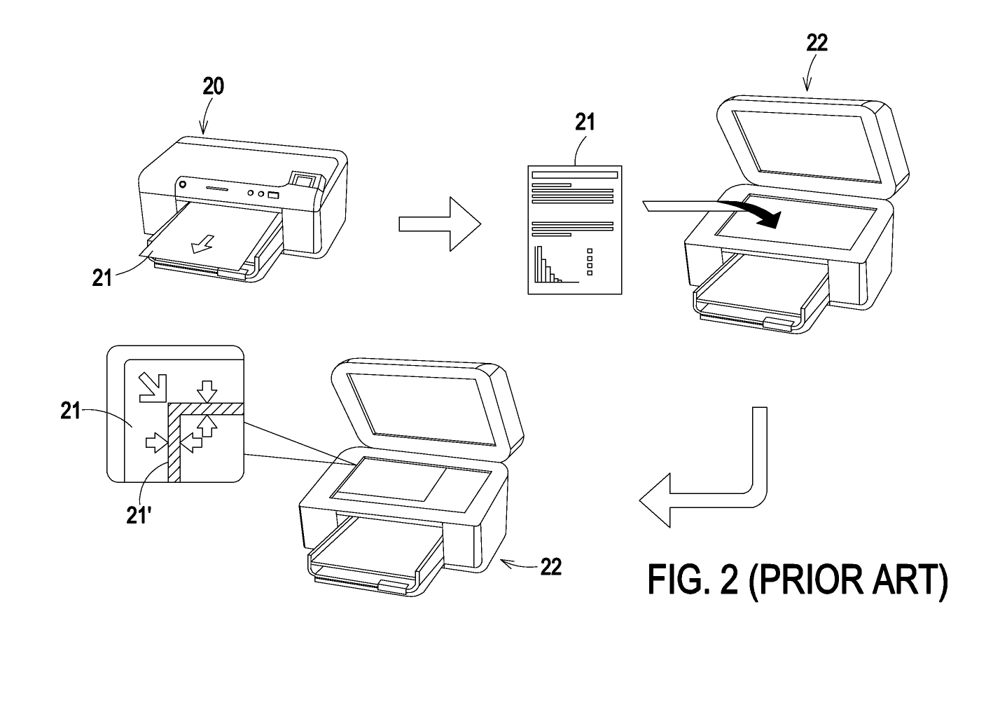

FIG. 3 schematically illustrates a portion of a page-width array printing device according to an embodiment of the present invention;

FIG. 4 is a flowchart illustrating an automatic printing adjustment method for the page-width array printing device of FIG. 3;

FIG. 5A schematically illustrating a procedure of performing a noise eliminating operation in the automatic printing adjustment method for the page-width array printing device of the present invention;

FIG. 5B schematically illustrating a procedure of performing a tilt calibration operation in the automatic printing adjustment method for the page-width array printing device of the present invention;

FIG. 6A schematically illustrating a procedure of performing a ROI selecting operation in the automatic printing adjustment method for the page-width array printing device of the present invention;

FIG. 6B schematically illustrating a procedure of performing a horizontal detection operation in the automatic printing adjustment method for the page-width array printing device of the present invention;

FIG. 6C schematically illustrating a procedure of performing a vertical detection operation in the automatic printing adjustment method for the page-width array printing device of the present invention; and

FIG. 7 schematically illustrates a printed image of the print medium before and after calibrated by the automatic printing adjustment method of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

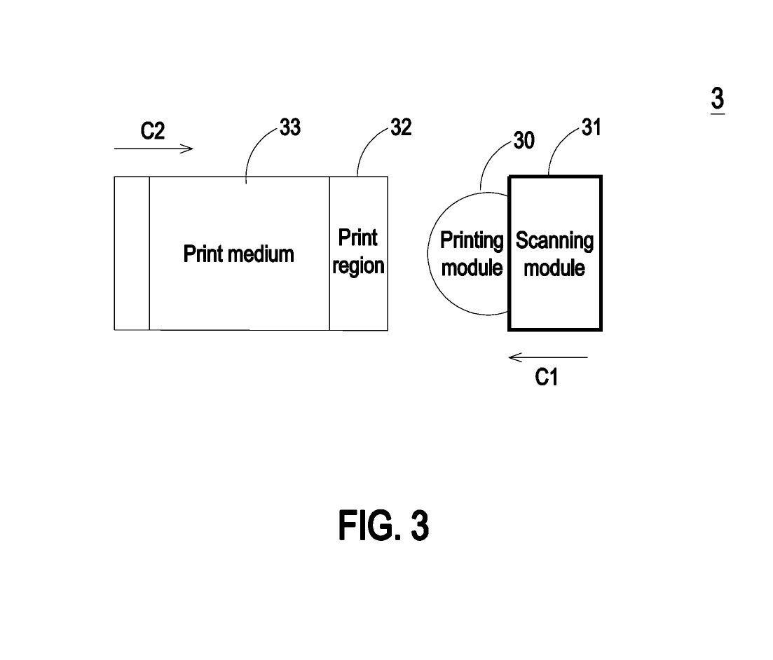

FIG. 3 schematically illustrates a portion of a page-width array printing device according to an embodiment of the present invention. As shown in FIG. 3, the page-width array printing device 3 comprises a printing module 30 and a scanning module 31. In this embodiment, the printing module 30 and the scanning module 31 are arranged in parallel. The page-width array printing device 3 further comprises a print region 32. A print medium 33 is placed on the print region 32 in order to be printed by the printing module 30. During the printing procedure, the printing module 30 is moved relative to the print region 32 in the direction C1 in order to print the print medium 33. Alternatively, in another embodiment, the printing module 30 is immobile, but the print region 32 is moved relative to the printing module 30 in the direction C2. When the print region 32 is moved to the printing module 30, the print medium 33 is printed by the printing module 30.

In this embodiment, since the scanning module 31 is arranged downstream of the printing module 30 and the scanning module 31 and the printing module 30 are arranged in parallel, the printing module 30 and the scanning module 31 may be linked with each other. When the printing module 30 is moved relative to the print region 32 to perform the printing task, the scanning module 31 is correspondingly moved to capture the printed image of the print medium 33. That is, the printing procedure and the image capturing procedure are simultaneously performed. Alternatively, the printing procedure of the printing module 30 and the image capturing procedure of the scanning module 31 may be performed in stages. That is, the printing procedure and the image capturing procedure may be sequentially or simultaneously performed. By the automatic printing adjustment method of the present invention, the artificially-made calibrating error will be avoided, and the calibrating precision and accuracy will be increased.

An example of the scanning module 31 includes but is not limited to a contact image sensor (CIS), a charge coupled device (CCD) or a camera. Moreover, the printing module 30 comprises a plurality of inkjet head structures (not shown). Each of the inkjet head structures comprises a plurality of nozzles (not shown).

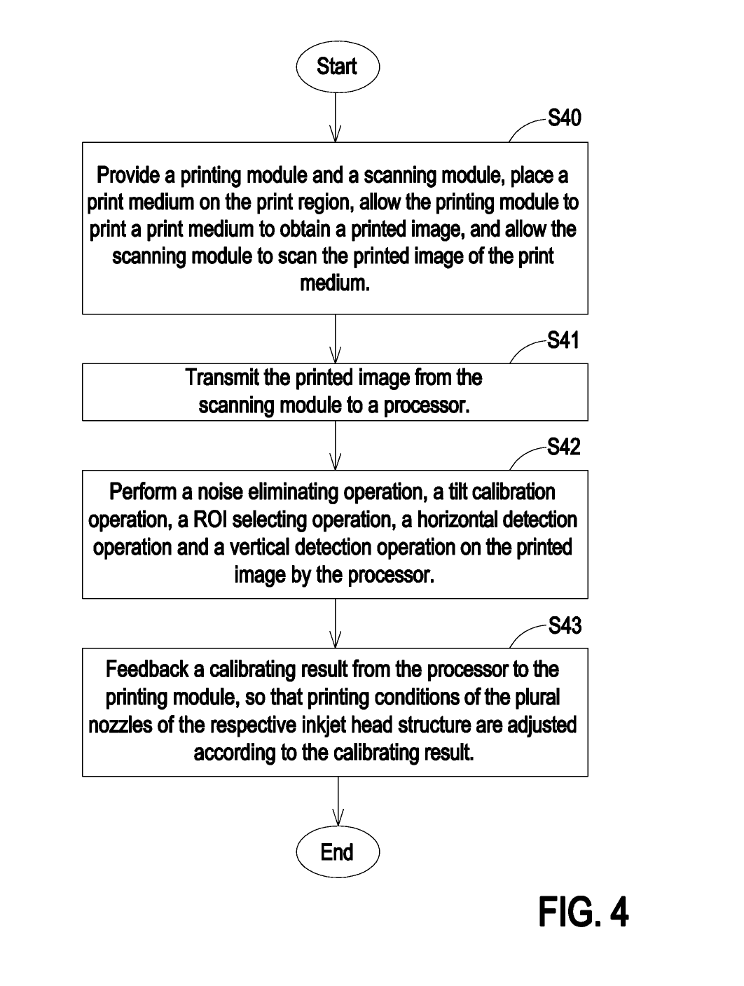

FIG. 4 is a flowchart illustrating an automatic printing adjustment method for the page-width array printing device of FIG. 3. As shown in FIGS. 3 and 4, firstly, in the step S40, when an automatic printing adjustment method for the page-width array printing device 3 is performed, a printing module 30 and a scanning module 31 are provided and a print medium 33 is placed on the print region 32. Since the scanning module 31 is arranged downstream of the printing module 30 and the printing module 30 and the scanning module 31 are in parallel arrangement and moved relative to the print region 32, after the print medium 33 is printed by the printing module 30, the printed image of the print medium 33 is captured by the scanning module 31. Especially, the printing procedure and the image capturing procedure are simultaneously or sequentially performed. In an embodiment, the print medium 33 is continuously placed on the print region 32 while the print medium 33 is printed by the printing module 30 and the printed image is scanned by the scanning module 31. After the image capturing procedure is performed by the scanning module 31, the printed image of the print medium 33 is transmitted from the scanning module 31 to a processor (Step S41). The processor is a desktop computer, a notebook computer or a tablet computer. Then, a noise eliminating operation, a tilt calibration operation, a ROI (region of interest) selecting operation, a horizontal detection operation, a vertical detection operation and/or any other appropriate calibrating operation are performed by the processor (Step S42). Consequently, the arrangement errors of the nozzles corresponding to the printed points of the printed image of the print medium 33 can be realized. After the arrangement errors of the nozzles are realized, the errors of the printed points of the printed image can be correspondingly adjusted. Then, in the step S43, the calibrating result is feedback to the printing module 30, and the printing conditions of the plural nozzles of the respective inkjet head structure are adjusted according to the calibrating result. The printing condition includes for example the printing time difference between the plural nozzles of adjacent inkjet head structures or the printing time difference between the plural nozzles of a single inkjet head structure. After the nozzles of the inkjet head structures are adjusted, the subsequent printing process is performed. Under this circumstance, the purpose of automatically and precisely correcting the printing device is achieved.

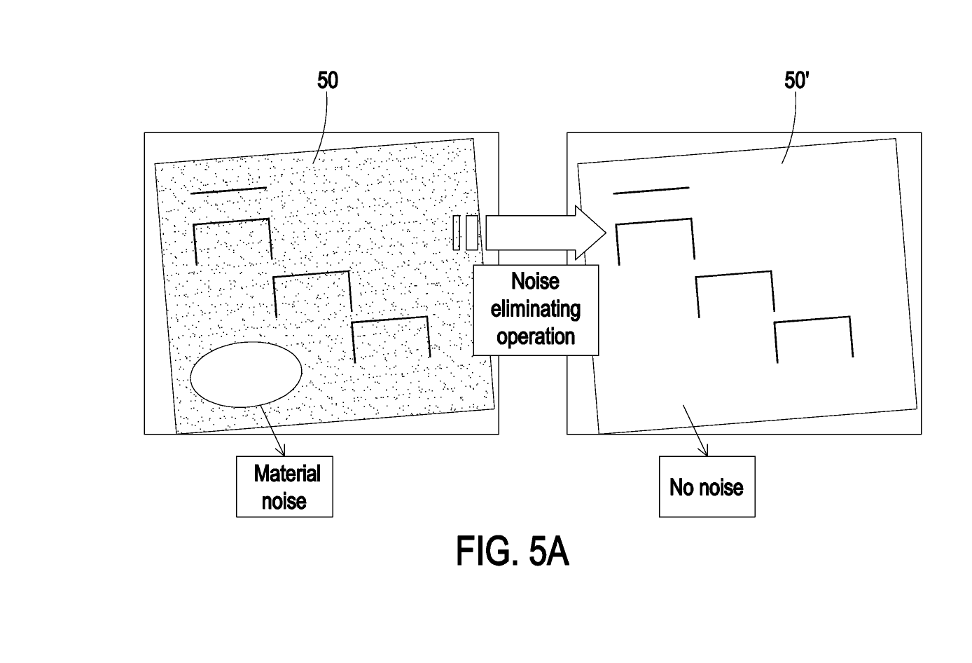

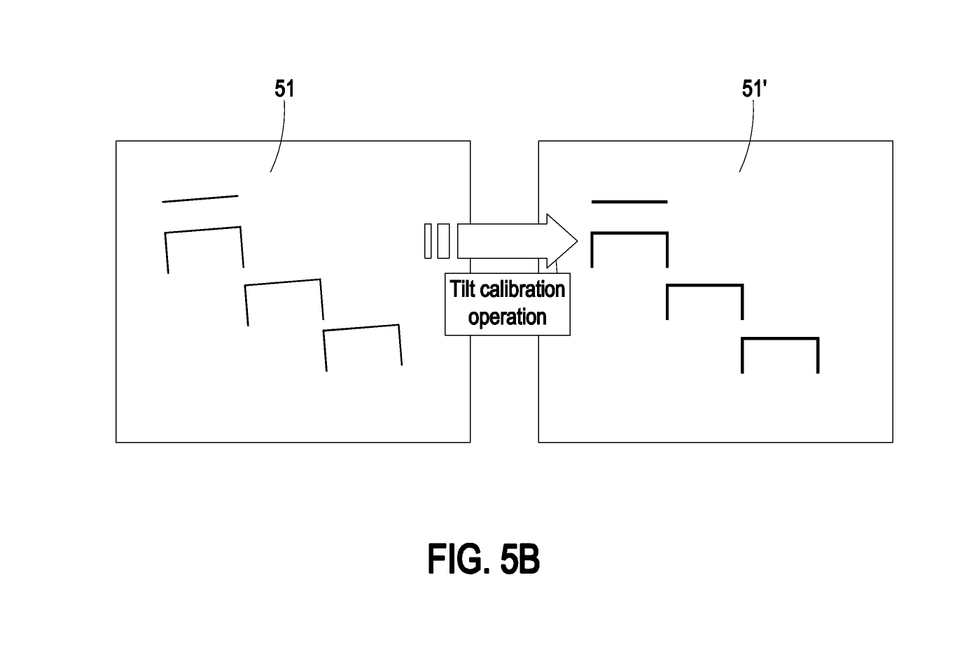

FIG. 5A schematically illustrating a procedure of performing a noise eliminating operation in the automatic printing adjustment method for the page-width array printing device of the present invention. In the automatic printing adjustment method for the page-width array printing device 3 of the present invention, the noise eliminating operation is performed by the processor. For performing the noise eliminating operation, the noise signal of the printed image 50 of the print medium is firstly detected and then the noise signal is eliminated. For example, the noise signal is the noise that is caused by the material of the print medium after scanned. After the noise eliminating operation is performed, the calibration result 50′ is obtained. Under this circumstance, the interference of the noise signal is minimized.

FIG. 5B schematically illustrating a procedure of performing a tilt calibration operation in the automatic printing adjustment method for the page-width array printing device of the present invention. In the automatic printing adjustment method for the page-width array printing device 3 of the present invention, the tilt calibration operation is performed by the processor. For performing the tilt calibration operation, a tilt angle of the printed image 51 of the print medium is firstly detected and then the tilt angle of the printed image 51 is corrected. For example, if the feed direction of the print medium is inclined or the printing device is carelessly touched, the printed image 51 is possibly tilted. After the tilt calibration operation is performed, the calibration result 51′ is obtained. Under this circumstance, the interference of the tilted situation is minimized.

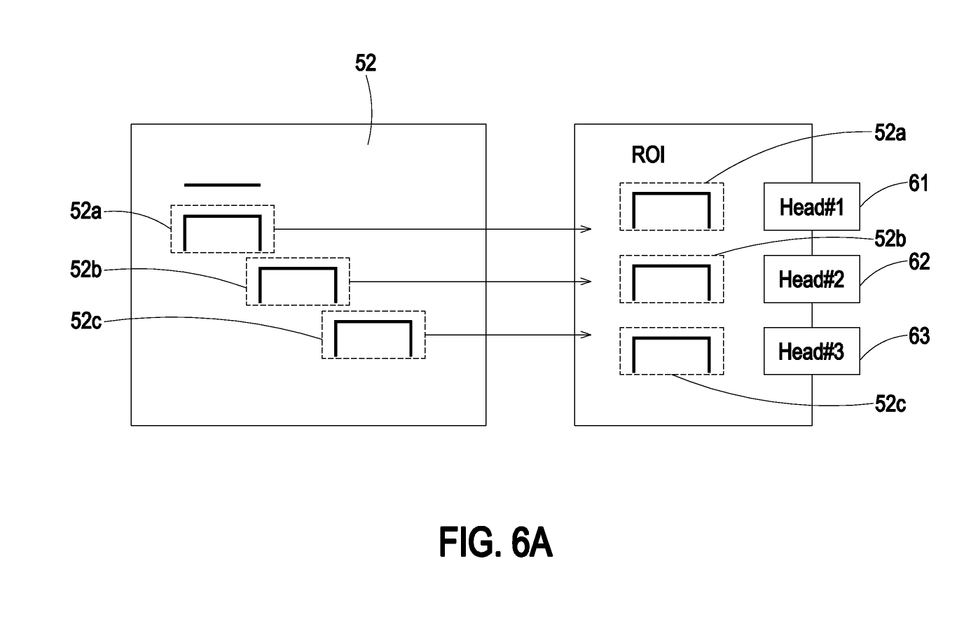

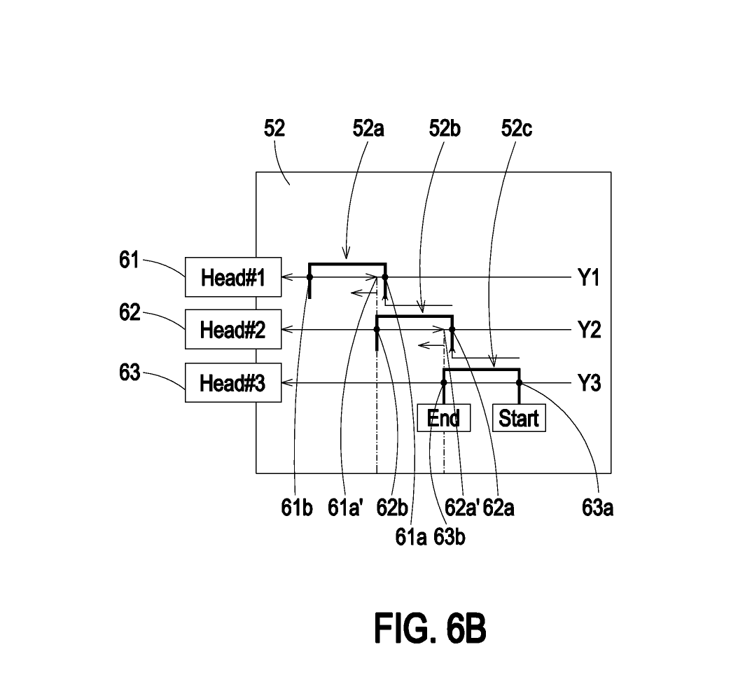

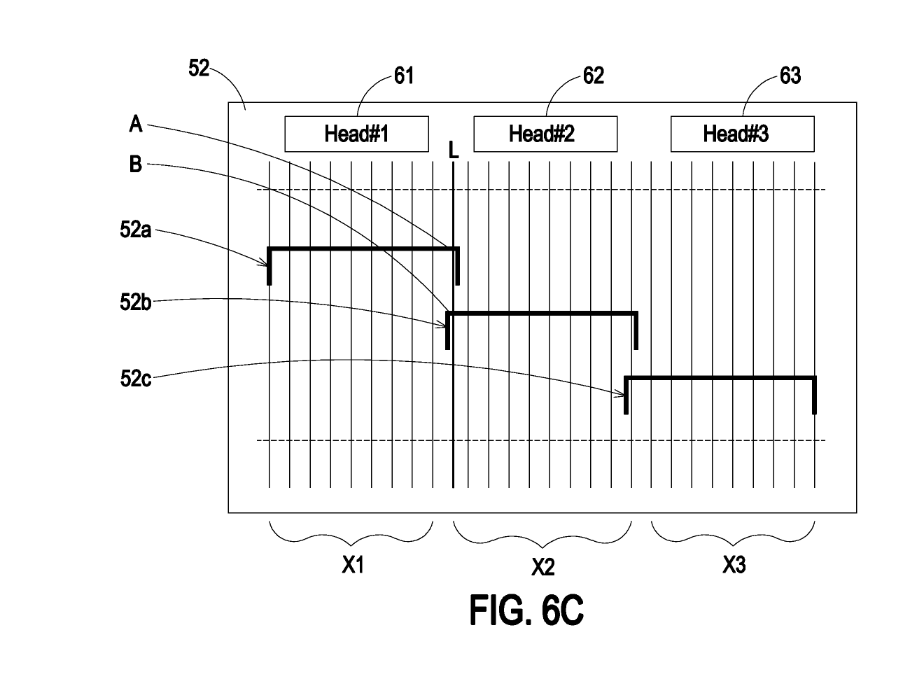

FIG. 6A schematically illustrating a procedure of performing a ROI selecting operation in the automatic printing adjustment method for the page-width array printing device of the present invention. Please refer to FIGS. 4 and 6A. In the automatic printing adjustment method for the page-width array printing device 3 of the present invention, the ROI selecting operation is performed by the processor. For performing the ROI selecting operation, the overlap region of the printed image of the print medium are judged firstly. Namely, the printed image 52 of the print medium 33 is captured by the scanning module 31 and the overlap regions of the printed image 52 of the print medium 33 are individually judged. Since the printing module 30 is a wide format printing module and comprises a plurality of inkjet head structures (not shown), the positions of the inkjet head structures are determined according to the practical requirements. For precise detection, the overlap region between adjacent inkjet head structures and the position errors of these inkjet head structures should be calibrated or adjusted. For performing the ROI selecting operation, the overlap regions of the printed image 52 of the print medium 33 are individually judged. After the ROI selecting operation is performed, the overlap regions of the printed image 52 of the print medium 33 are realized. For example, if the printed image 52 has a plurality of blocks 52a, 52b and 52c with vertical overlap lines, after the ROI selecting operation is performed, the blocks 52a, 52b and 52c are correspondingly printed by the inkjet head structures 61, 62 and 63, respectively. Since separate regions are printed by the inkjet head structures 61, 62 and 63, the detecting flexibility is enhanced. Moreover, since the data amount is reduced, the detecting speed is increased.

In an embodiment, after the ROI selecting operation is performed, a horizontal detection operation is performed on the printed image of the print medium. FIG. 6B schematically illustrating a procedure of performing a horizontal detection operation in the automatic printing adjustment method for the page-width array printing device of the present invention. After the printed image 52 of the print medium 33 is generated by the printing module 30, the regions of interest (ROI) are judged by the processor (not shown), and then the horizontal detection operation is performed on the printed image 52 by the processor. As known, the arrangements of different inkjet head structures 61, 62 and 63 may be different. For achieving the complementary printing function, there are some overlap regions between the inkjet head structures 61, 62 and 63. Due to the overlap regions, the flexibility of designing the inkjet head structures is enhanced. However, for preventing from generating abnormal color, the nozzles corresponding to the overlap regions between the inkjet head structures 61, 62 and 63 should be accurately judged. As mentioned above, the blocks 52a, 52b and 52c of the printed image 52 are correspondingly printed by the inkjet head structures 61, 62 and 63, respectively. During the horizontal detection operation, three horizontal lines Y1, Y2 and Y3 are used as datum lines for calibrating the ink trajectories. The three horizontal lines Y1, Y2 and Y3 are related to the nozzles corresponding to the blocks 52a, 52b and 52c, respectively. As shown in FIG. 6B, the inkjet head structure 63 corresponding to the block 52c has a start point 63a and an end point 63b. That is, the block 52c is printed by all of the nozzles of the inkjet head structure 63. Moreover, the inkjet head structure 62 corresponding to the block 52b has a start point 62a and an end point 62b. In this embodiment, the nozzles from the print beginning point 62a′ to the end point 62b of the inkjet head structure 62 are responsible for printing the lines between the print beginning point 62a′ and the end point 62b and the line between the start point 62a and the print beginning point 62a′ is printed by the inkjet head structure 63, so that the overlap region is not double printed. The inkjet head structure 61 corresponding to the block 52a has a start point 61a and an end point 61b. Similarly, the nozzles from the print beginning point 61a′ to the end point 61b of the inkjet head structure 61 are responsible for printing the lines between the print beginning point 61a′ and the end point 61b and the line between the start point 61a and the print beginning point 61a′ is printed by the inkjet head structure 62, so that the overlap region is not double printed. In other words, the nozzles from the print beginning point 61a′ to the end point 61b of the inkjet head structure 61 are responsible for printing the block 52a, but the nozzles from the start point 61a to the print beginning point 61a′ of the inkjet head structure 61 are not used. After the horizontal detection operation is performed, the horizontal arrangement of the inkjet head structures 61, 62 and 63 can be realized, and the horizontal position errors of the inkjet head structures 61, 62 and 63 are fed back to the processor. By controlling the printing time differences between the adjacent nozzles of the inkjet head structures 61, 62 and 63 and controlling the operations of the nozzles of the inkjet head structures 61, 62 and 63, the possibility of causing the double printing situation will be minimized.

In another embodiment, after the ROI selecting operation is performed, a vertical detection operation is performed on the printed image of the print medium. FIG. 6C schematically illustrating a procedure of performing a vertical detection operation in the automatic printing adjustment method for the page-width array printing device of the present invention. After the printed image 52 of the print medium 33 is generated by the printing module 30 and the horizontal detection operation is performed by the processor, a vertical detection operation is performed on the printed image 52 by the processor. As known, the arrangements of different inkjet head structures 61, 62 and 63 may be different. For example, the inkjet head structures 61, 62 and 63 may be staggered in the vertical direction. Under this circumstance, the printed lines are possibly disordered. For shifting the disordered lines, the errors between the inkjet head structures 61, 62 and 63 should be accurately judged and corrected. During the vertical detection operation, plural vertical lines are used as datum lines for calibrating the ink trajectories. For example, the datum line L is arranged between the inkjet head structures 61 and 62. Moreover, corresponding to the inkjet head structures 61, 62 and 63 and the blocks 52a, 52b and 52c, the plural vertical lines are classified into three groups X1, X2 and X3. Ideally, the intersections between each datum lines and the blocks 52a, 52b and 52c indicate the printing positions of the nozzles of the inkjet head structures 61, 62 and 63. As shown in FIG. 6C, the inkjet head structure 61 has a printing position A, and the inkjet head structure 62 has a printing position B. The printing position A of the inkjet head structure 61 and the printing position B of the inkjet head structure 62 are located at two opposite sides of the datum line L. That is, the nozzles corresponding to printing position A and the printing position B are not aligned with each other to print a straight line. By performing the vertical detection operation, the printing time difference between the nozzle of the inkjet head structure 61 and the datum line L and the printing time difference between the nozzle of the inkjet head structure 62 and the datum line L are adjusted and the operations of the nozzles of the inkjet head structures 61 and 62 are controlled. For example, the printing time of the nozzle at the printing position A of the inkjet head structure 61 is advanced, and the printing time of the nozzle at the printing position B of the inkjet head structure 62 is delayed. After the vertical detection operation, the inkjet head structures 61 and 62 can print a straight line. Consequently, even if a complementary printing function is achieved by the inkjet head structures 61, 62 and 63, the printed points created by the inkjet head structures 61, 62 and 63 are not suffered from misalignment. After the vertical detection operation is performed, the vertical arrangement of the inkjet head structures 61, 62 and 63 can be realized, and the vertical position errors of the inkjet head structures 61, 62 and 63 are fed back to the processor. By controlling the printing time differences between the adjacent nozzles of the inkjet head structures 61, 62 and 63 and controlling the operations of the nozzles of the inkjet head structures 61, 62 and 63, the printing range can be realized and the possibility of causing the double printing situation will be minimized.

From the above discussions, the calibrating operation used in the automatic printing adjustment method of the present invention comprises the noise eliminating operation, the tilt calibration operation, the ROI selecting operation, the horizontal detection operation and the vertical detection operation. After the automatic printing adjustment method of the present invention is implemented, the interference of the noise signal caused by the material of the print medium, the skew problem caused by the misalignment of the inkjet head structure and the skewed or blurred image caused by the misalignment of the nozzles or the clogged or lacked nozzles will be corrected.

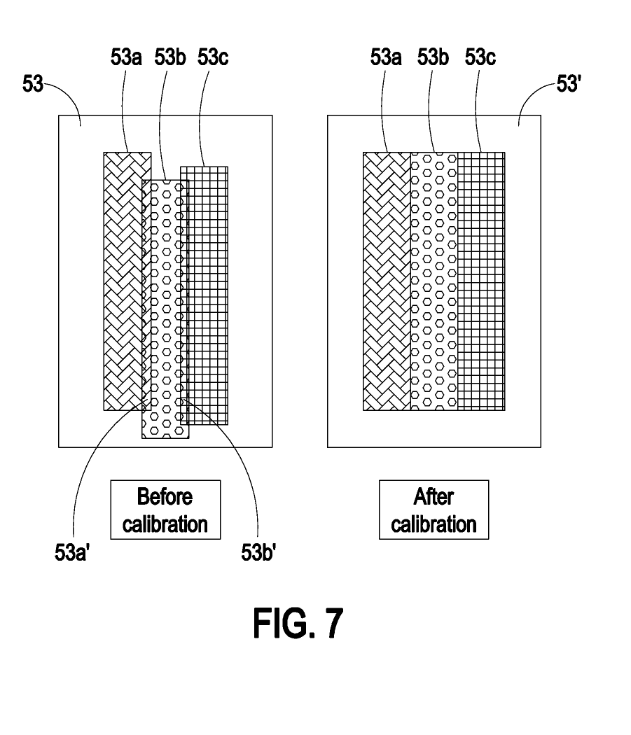

FIG. 7 schematically illustrates a printed image of the print medium before and after calibrated by the automatic printing adjustment method of the present invention. As shown in FIG. 7, the printed image 53 of the print medium 33 has a polychromatic overprint effect. For example, the color blocks 53a, 53b and 53c have different colors (e.g. cyan, magenta and yellow colors). The color blocks 53a, 53b and 53c are printed by different inkjet head structures (not shown). Before the automatic printing adjustment method of the present invention is performed, the junctions between the color blocks 53a, 53b and 53c have polychromatic overprints. For example, the junction between the color block 53a and the color block 53b has a blue overprint 53a′ of the cyan color and the magenta color; and the junction between the color block 53b and the color block 53c has a red overprint 53b′ of the magenta color and the yellow color. The polychromatic overprint effect may be caused by the position errors of the inkjet head structures. Moreover, since the inkjet head structures are staggered, the color blocks 53a, 53b and 53c are disordered.

For calibrating the inkjet head structures, the automatic printing adjustment method of the present invention should be performed. After the noise eliminating operation is performed (see FIG. 5A), the noise signal of the printed image that is caused by the material textures of the print medium is eliminated. After the tilt calibration operation is performed (see FIG. 5B), the skewed image that is caused by feeding or transporting the print medium inclinedly is eliminated. After the ROI selecting operation is performed (see FIG. 6A), the overlap regions of the printed image are realized. After the horizontal detection operation is performed (see FIG. 6B), the nozzles of the inkjet head structures along the horizontal direction are not used for double printing, and the printing time differences between the adjacent nozzles of the inkjet head structures are controlled, so that a straight line along the horizontal direction can be printed by the inkjet head structures. After the vertical detection operation is performed (see FIG. 6C), the nozzles of the inkjet head structures along the vertical direction are not used for double printing, and the printing time differences between the adjacent nozzles of the inkjet head structures are controlled, so that a straight line along the vertical direction can be printed by the inkjet head structures. After the above calibrating operations are completed, a calibration result 53′ is obtained. In the calibration result 53′, the polychromatic overprint effect is largely reduced and the color blocks 53a, 53b and 53c are well aligned with each other. Consequently, the calibrating efficacy and the image quality are both enhanced.

From the above descriptions, the present invention provides an automatic printing adjustment method for a page-width array printing device. The page-width array printing device comprises a printing module and a scanning module. The scanning module is arranged downstream of the printing module, and the printing module and the scanning module are in parallel arrangement. Especially, the printing procedure of the printing module and the image capturing procedure of the scanning module are simultaneously or sequentially performed. After a noise eliminating operation, a tilt calibration operation, a ROI selecting operation, a horizontal detection operation and a vertical detection operation are performed, the print result is automatically detected, the artificially-made printing calibrating error is minimized, the calibrating resolution is increased, and the calibrating efficacy and the image quality are both enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic printing adjustment method for a page-width array printing device, the page-width array printing device comprising a printing module, a scanning module and a print region, the printing module comprising a plurality of inkjet head structures, each inkjet head structure comprising a plurality of nozzles, the automatic printing adjustment method comprising steps of:
(a) allowing the printing module to print a print medium placed on the print region to obtain a printed image and allowing the scanning module to scan the printed image of the print medium;
(b) transmitting the printed image from the scanning module to a processor;
(c) performing a noise eliminating operation, a tilt calibration operation, a ROI (region of interest) selecting operation, a horizontal detection operation and a vertical detection operation on the printed image by the processor; and
(d) feedback a calibrating result from the processor to the printing module, so that printing conditions of the nozzles of the respective inkjet head structure are adjusted according to the calibrating result.

2. The automatic printing adjustment method according to claim 1, wherein the printing module and the scanning module are arranged in parallel and relative movement of the print region.

3. The automatic printing adjustment method according to claim 1, wherein after the noise eliminating operation in the step (c) is performed, a noise contained in the printed image of the print medium is eliminated.

4. The automatic printing adjustment method according to claim 1, wherein after the tilt calibration operation in the step (c) is performed, a tilt angle of the printed image of the print medium is corrected.

5. The automatic printing adjustment method according to claim 1, wherein after the ROI selecting operation in the step (c) is performed, a plurality of overlap regions of the printed image corresponding to the inkjet head structures are individually determined.

6. The automatic printing adjustment method according to claim 5, wherein after the horizontal detection operation in the step (c) is performed, horizontal arrangements of the inkjet head structures are realized, and horizontal position errors of the inkjet head structures are fed back to the processor, wherein printing time differences between adjacent nozzles of the inkjet head structures are adjusted according to the horizontal position errors, so that the nozzles of the inkjet head structures along a horizontal direction are not used for double printing.

7. The automatic printing adjustment method according to claim 5, wherein after the vertical detection operation in the step (c) is performed, vertical arrangements of the inkjet head structures are realized, and vertical position errors of the inkjet head structures are fed back to the processor, wherein printing time differences between adjacent nozzles of the inkjet head structures are adjusted according to the vertical position errors, so that the nozzles of the inkjet head structures along a vertical direction are not used for double printing.

8. The automatic printing adjustment method according to claim 1, wherein the scanning module is a contact image sensor, a charge coupled device or a camera.
